(19) United States
(12) Patent Application Publication
(10) Pub. No.: US 2002/0184314 A1
(43) Pub. Date: Dec. 5, 2002

(54) Method and system for transmitting multicast data signals

(76) Inventor: John George Riise, Frederiksberg (DK)

Correspondence Address: JACOBSON HOLMAN, PROFESSIONAL LIMITED LIABILITY COMPANY, 400 SEVENTH STREET, N. W., WASHINGTON, DC, 20004, US

(21) Appl. No.: 10/144,752

(22) Filed: May 15, 2002

Related U.S. Application Data
(60) Provisional application No. 60/291,330, filed on May 17, 2001.

(30) Foreign Application Priority Data
May 15, 2001 (DK) PA 2001 00762

(51) Int. Cl. G06F 15/16; H04N 7/10; H04N 7/025

(52) U.S. Cl. 709/205; 709/219; 725/32

(57) ABSTRACT

Disclosed is a method of transmitting customised program data from a program source (301) to a receiver (304). The method comprises the steps of multicasting data signals from one or more program sources via different transmission channels (305a-d) of a communications network, where the data signals comprise respective sequences of program sections; transmitting a first control signal from a control means (312) to a selecting means (302), the first control signal being indicative of a customised sequence of program sections; in response to the first control signal causing the receiver by the selecting means to receive program sections from selected ones of the first and second transmission channels in a predetermined order corresponding to the customised sequence of program sections.

### FIELD OF THE INVENTION

This invention relates to the transmitting and receiving of customised program data.

### BACKGROUND OF THE INVENTION

Many modern communications applications comprise a one-to-many or many-to-many transmission of data, where one or multiple sources are sending to multiple receivers. Examples of such applications include the transmission of corporate messages to employees, the communication of stock quotes to brokers, video and audio conferencing applications, and the replication of databases and web site information. In traditional point-to-point unicast communication, the source sends an individual copy of a message to each receiver. This method has the disadvantage, that the bandwidth required to send a message to a large number of receivers increases proportional to the number of receivers. In general, when sending a large number of different customised data streams from a central server via a communications network, a large amount of network resources are required.

In multicast communication within a communications network, a source may send a single copy of a message to multiple recipients. Hence, in multicast communications, only one copy of a multicast message passes over any link in the network, and copies of the message need only to be made where paths diverge, e.g. at a router. An example of a multicast protocol used for Internet applications is the IP multicast protocol, an extension to the standard Internet Protocol (IP) A special case of multicast communication is broadcast communication known from e.g. traditional television or radio broadcasting. In broadcast communications one copy of a message is sent to all reachable nodes on the network. However, many nodes may not want to receive the broadcasted message, and broadcasting a large number of different messages to all nodes of a network requires a large bandwidth.

The above prior art has the disadvantage, that all recipients of a multicast data signal receive the same data. Consequently, the program material transmitted is not customised to the individual users, but rather to a group of users. A customised transmission to individual users may, however, be desired for an individualised transmission of commercials, news programs, interactive television contents, or other program material.

From European Patent application EP 986 256 it is known to select a desired television signal from a plurality of broadcast television signals by comparing a code superimposed to the received television signals with a code stored at the receiver, and displaying the content of the signal with a matching code.

However, this prior art comprises the disadvantage that the receiver needs to receive all the coded television channels in order to compare the superimposed codes with the stored code. Consequently, the above prior art method involves the problem that it requires a high bandwidth available at the receiver. In particular, this is a problem when broadcasting a large number of alternative television signals or in communications networks, such as the Internet, where the connection between a service provider and the individual receiver often has a small bandwidth and may even be a bottleneck of the transmission.

It is further known to pre-buffer television commercials. This pre-buffering includes a transmission of plural alternative television commercials to a plurality of receivers in advance. The television commercials are stored in a memory medium of the respective receivers. In a commercial break between television programs, selected ones of the stored television commercials may be displayed on the different receivers.

This pre-buffering of television commercials has the disadvantage, that it requires storage capacity at the receiver which increases with the amount of data transmitted. In particular, this is a disadvantage in connection with the emergence of high-quality digital television and the corresponding increase in transmitted data. Furthermore, the above pre-buffering requires that data is transmitted during a period of time before the actual display of a television commercial. The time required for the transmission also depends on the amount of data per television commercial. Consequently, pre-buffering of television commercials is limited to brief high-quality television clips with long periods between commercial breaks.

### SUMMARY OF THE INVENTION

The above and other problems are solved by a method of transmitting customised program data from a number of program sources to a receiver, the method comprising the steps of

multicasting a first data signal from a first one of the number of program sources via a first transmission channel of a communications network, the first data signal comprising a first sequence of program sections;

multicasting a second data signal from a second one of the number of program sources via a second transmission channel of the communications network, the second data signal comprising a second sequence of program sections;

transmitting a first control signal from a control means to a selecting means associated with the receiver, the first control signal being indicative of a customised sequence of program sections;

in response to the first control signal causing the receiver by the selecting means to selectively receive program sections from selected ones of the first and second transmission channels in a predetermined order corresponding to the customised sequence of program sections.

Consequently, it is an advantage of the invention that it provides a high degree of individualised program reception with a small consumption of communications bandwidth. As the program data is transmitted as sequences of sections of a program, and the receiver is controlled by the selecting means to receive program sections from two or more transmission channels in a predetermined order, the receiver receives individualised program content as a customised combination of program sections. Due to the large number of different combinatorial possibilities of generating a sequence of program sections, a high degree of customisation is achieved. Furthermore, as the receiver is controlled via a control signal to switch between transmission channels in a predetermined order without the need for checking the codes of all possible channels, the receiver only receives data from one or a few selected channels of the plurality of different transmission channels at any time. Consequently, the required bandwidth at the interface of the receiver to the communications network is greatly reduced while, at the same time, allowing for a high degree of flexibility and customisation of the individual programs.

Hence, it is an advantage of the invention that it reduces bandwidth bottlenecks at the interface of a receiver of customised program data streams, i.e. it reduces bottlenecks at the so-called “last-mile” of the data transmission in a computer network close to the client receiver. As the communication lines to the individual clients, e.g. telephone lines from a household to an Internet service Provider (ISP), typically have a much lower capacity as the backbone of the communications network it is an advantage of the invention that it reduces bandwidth requirements at this interface.

At the same time, as the selection of a customised sequence is performed decentralised by a selection module associated with the receiver, a transmission of a large number of individual customized programs via the communications network is avoided, thereby reducing the network traffic and the outgoing bandwidth requirement of the program servers.

The term program data comprises any type of program material which may be transmitted via a communications network. Examples of program data include broadcast programs such as television programs, e.g. digital television according to a digital video compression standard such as MPEG, audio programs or the like. Other examples of program data include graphical animations, computer games, or the like.

In a preferred embodiment of the invention the program data comprises a television program.

The program sections may comprise short sections of a broadcast program, such as advertisement spots, news spots or features, or scenes of a video program. Hence, a receiver may receive a customised program, e.g. a customised commercial break, news program, etc., by receiving program sections in a customised order, thereby providing an individualised program. Alternatively or additionally, the program sections may comprise graphical objects to be displayed within a video program, dynamic objects of a video presentation, customised scenes of a video program, sections of an audio program, sections or objects of a multimedia program or presentation, etc.

When the second sequence of program sections has a predetermined temporal relationship to the first sequence of program sections, a particularly large number of customised sequences of program sections may be received without increasing the required bandwidth, as undesired overlaps between program sections which may have to be received simultaneously may be avoided. It is a further advantage of the invention that the available bandwidth may be utilised to a high degree. For example, the multicasting of a program section may be initiated while the transmission of a previous section with a lower bandwidth requirement is still ongoing.

When the second sequence of program sections is substantially synchronised with the first sequence of program sections, the receiver may switch from receiving a program section via one transmission channel to receiving a subsequent program section via another transmission channel without an interruption of the data flow which may be perceived as annoying by a user. Hence, a substantially continuous flow of data may be received without requiring additional bandwidth.

The control means may be any suitable control circuit adapted to generate said control signal based on information about the transmitted program sequences and the desired customised program signal to be received by the receiver. The control means may comprise general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. For example, the control means may comprise a computer system controlling the first and second program sources or a computer system receiving information from the program sources about the transmitted program sections. The control signal may be transmitted via the communications network, e.g. embedded in one of the transmission channels. Alternatively, the control signal may be transmitted via a separate control connection.

In a preferred embodiment of the invention the step of receiving a customised sequence of program sections comprises the steps of

receiving at least a first program section of the first sequence of program sections from the first transmission channel; and

at a predetermined time initiating receiving at least a second program section from the second sequence of program sections from the second transmission channel.

In a preferred embodiment of the invention at least a third program section of the customised sequence of program sections comprises a program data object. A program data object may be an object of an object-oriented standard for representing program data, e.g. a multimedia object of a standard for video, audio or graphical presentations, such as the MPEG-4 standard. Hence, different alternative objects may be multicast by one or more program sources, and a receiver may receive a customised presentation as a customised sequence of objects where the individual objects of the sequence may overlap in time.

A program source may be a system adapted to multicast program data via a communications network, for example a provider system for providing program data material, e.g. a system of a digital television provider or a provider of other broadcast program material. Preferably, the program source comprises a network interface unit for multicasting data signals via a communications network. The communications network may be any suitable communications network, such as an intranet, the Internet, a digital television network or another broadcast network. Preferably, the communications network uses one or more suitable communications protocols, e.g. IP, TCP, UDP, RTP, etc., or combinations thereof.

The first and second program sources may be different program sources or they may be comprised in the same program source.

In a preferred embodiment of the invention the communications network is the Internet, i.e. a communications network where the data signals are transmitted according to a TCP/IP protocol suite.

The term multicasting covers the transmission of a message to a group of recipients. The term includes broadcasting, i.e. sending a message to everyone connected to a network.

In a preferred embodiment of the invention the step of multicasting a selected one of the first and second sequences of program sections comprises transmitting the corresponding first or second sequence of program sections via an IP multicast protocol, i.e. a multicast protocol which follows the IP multicast standard. It is an advantage of the invention that existing standards for multicast transmission over the Internet may be utilised.

A receiver or client system may comprise a computer, such as a PC which may connect to the Internet, e.g. via an Internet Service Provider (ISP), e.g. via a telephone line, ISDN, DSL, via a LAN, or the like. Alternatively or additionally, the receiver may comprise a set-top box or a game console connected to a television, another display device, or the like, and connected to the communications network, e.g. a digital television network, and intranet, the Internet, etc. Further examples of receivers include mobile terminals, such as mobile phones, PDAs, communicators, etc.

The term selecting means comprises any circuitry adapted to switch between a number of transmission channels. The selecting means may comprise general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. The selecting means may be implemented as part of a client system comprising the receiver.

Alternatively, the selecting means may be implemented in a network component of the communications network, i.e. separate from the receiver. In one embodiment, the selecting means is implemented in a network server which provides network access to the receiver. This may, for example, be a network server of an Internet Service Provider (ISP). This has the advantage that no switching hardware and/or software is required at the receiver.

In the case of IP multicast protocol, the selecting means may be embodied as a computer program implementing a part of a communications stack of a network server which implements the IP multicast protocol. Hence it is an advantage that IP multicast functionality may be used to selectively subscribe and unsubscribe to a number of multicast groups, thereby switching reception between different data streams.

It is an advantage of this embodiment that only the selected data stream needs to be forwarded to higher layers of the communications stack.

In a preferred embodiment of the invention the step of causing the receiver by the selecting means to selectively receive program sections comprises the step of switching between receiving data from the first transmission channel and the second transmission channel in a predetermined order.

In a preferred embodiment of the invention the step of causing the receiver by the selecting means to receive program sections further comprises the steps of

receiving program sections of the first and second sequences of program sections at a node of the communications network via the corresponding first and second transmission channels; and

transmitting the customised sequence of program sections from the node to the receiver.

It is a further advantage of the invention that only one transmission channel may need to be transmitted from the network node generating the customised sequence of program sections to the receiver. Hence, the receiver does not need to have a large bandwidth available to it. Preferably, the network node comprises a router, i.e. a device or software on a computer that determines the network nodes to which a data signal, e.g. a data packet, should be forwarded.

In a preferred embodiment of the invention the method further comprises the steps of

receiving a first data item from the control means by the selecting means, the first data item being indicative of at least a selected one of the first and second program sources;

transmitting a second data item from the selecting means to the node of the communications network, the second data item corresponding to a request for receiving program sections of the corresponding first or second sequence of program sections from the corresponding first or second program source.

Consequently, the control means may transmit control data to the selecting means, the control data being indicative of a program source from which to request a program section.

In another preferred embodiment of the invention the customised sequence of program sections is selected at least partly in response to one or more inputs received from a user via an input means.

It is an advantage of the invention that a number of alternative program sections may be multicast, allowing a user to select a desired section, thereby providing the possibility of receiving an interactive program. Examples of interactive programs include interactive video programs, where a viewer may select from a number of alternative characters or alternative continuations, so-called multi-threaded stories, or video games where a player may select alternative scenarios, characters, levels, etc.

The input means may be a keyboard, e.g. the keyboard of a computer or the keypad of a mobile terminal, a pointing device, e.g. a computer mouse, a track ball, a touch screen, a digital pen or the like, a joy stick, game pad, a remote control, or any other input device.

In a preferred embodiment of the invention the first data is item comprises a multicast network address. The network address may for example identify a network server or a multicast group.

In a further preferred embodiment of the invention the first data item is indicative of a plurality of alternative program sections; and the method further comprises the step of selecting a second program section from the plurality of alternative program sections by the selecting means in response to an input received from a user via an input means.

In another preferred embodiment of the invention a selected one of the first and second sequences of program sections comprises predetermined time intervals between the corresponding program sections. Consequently, the receiver may establish a connection to a transmission channel prior to the actual transmission of a program section without significantly increasing the required bandwidth. It is an advantage of the invention that it provides a robust method for receiving customised program data, as different connection times of different receivers may be compensated for without disturbing the flow of the received data.

In a further preferred embodiment of the invention the first and second sequences of program sections each comprise predetermined time intervals between the corresponding program sections; and the program sections of the first sequence of program sections are transmitted during time intervals corresponding to the predetermined time intervals between the program sections of the second sequence of program sections. Consequently, a receiver may switch between different transmission channels by connecting to a new channel during a time interval between transmitted program sections, thereby allowing for a fast switch from receiving a program section from one channel to receiving another section from another channel. The method according to the invention is therefore not sensitive to different connection times. It is a further advantage that the required bandwidth at the receiver is not increased significantly, as no, or at least only little, program data is received from a transmission channel during the intervals between program sections.

In another preferred embodiment, the method further comprises the steps of

receiving information about the receiver by the control means; and

in response to the received information, selecting a third program section by the control means to be transmitted as a part of a selected one of the first and second sequences of program sections.

Consequently, the contents of the transmitted sequences of program sections may be dynamically adapted according to the information received about the users which are currently connected, thereby providing a high degree of flexibility and allowing an efficient utilisation of the available bandwidth, as the transmitted program sections may be targeted at the currently connected users.

The invention further relates to a method of receiving customised program data by a receiver from a number of program sources, where a first one of the number of program sources multicasts a first data signal via a first transmission channel of a communications network, the first data signal comprising a first sequence of program sections, and a second one of the number of program sources multicasts a second data signal via a second transmission channel of the communications network, the second data signal comprising a second sequence of program sections; the method comprising the steps of

receiving a first control signal from a control means by a selecting means associated with the receiver, the first control signal being indicative of a customised sequence of program sections;

in response to the first control signal causing the receiver by the selecting means to selectively receive program sections from selected ones of the first and second transmission channels in a predetermined order corresponding to the customised sequence of program sections.

The invention further relates to a system for transmitting customised program data from a number of program sources to a receiver, the system comprising

a first program source adapted to multicast a first data signal via a first transmission channel of a communications network, the first data signal comprising a first sequence of program sections;

a second program source adapted to multicast a second data signal via a second transmission channel of the communications network, the second data signal comprising a second sequence of program sections;

control means adapted to transmit a first control signal, the first control signal being indicative of a customised sequence of program sections;

a receiver adapted to receive program sections from selected ones of the first and second transmission channels; and

selecting means associated with the receiver and adapted to cause the receiver, in response to the first control signal, to selectively receive program sections from selected ones of the first and second transmission channels in a predetermined order corresponding to the customised sequence of program sections.

The invention further relates to a receiver for receiving customised program data, the receiver comprising

receiving means for receiving a first data signal comprising a predetermined sequence of program sections; and

selecting means adapted to generate a control signal causing a routing means to select the predetermined sequence of program sections from a plurality of data signals and to route the predetermined sequence of program sections to the receiver, each one of the plurality of data signals comprising a respective sequence of program sections.

The invention further relates to a system for communicating customised program data, the system comprising

a number of program servers adapted to transmit sections of program data via a communications network, each of the sections of program data carrying a corresponding multicast group address;

a client system adapted to receive program data via the communications network;

a control server adapted to send a target multicast address indicative of at least a first one of the sections of program data to the client system;

a selection circuit comprised in the client system and adapted to generate and send a first control signal comprising control commands adapted to cause a router of the communications network to receive and route to the client system sections of program data carrying the target multicast address.

The invention further relates to a client system comprising

a communications circuit adapted to

receive sections of program data via a communications network, each of the sections of program data having associated a corresponding multicast group address, and

receive control data from a control server, the control data being indicative of a target multicast address identifying at least a first section of program data;

a processing unit adapted to generate a first control signal comprising control commands adapted to cause a router of the communications network to receive and route to the client system the at least first section of program data associated with said target multicast address; and

the communications circuit is further adapted to send the first control signal to a router of the communications network.

The communications circuit may comprise circuitry and/or devices suitable for enabling the communication of data, e.g. via a wired or a wireless data link. Examples of such receiving means include a network interface, a network card, a radio transmitter/receiver, a transmitter/receiver for other suitable electromagnetic signals, a cable modem, a telephone modem, an Integrated Services Digital Network (ISDN) adapter, a Digital Subscriber Line (DSL) adapter, a satellite transceiver, an Ethernet adapter, or the like.

The invention further relates to a data signal embodied in a carrier wave for use in a method described above and in the following, the data signal comprising a sequence of program sections.

It is noted that the features of the methods described above and in the following may be implemented in software and carried out in a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

The invention further relates to a computer program comprising program code means for performing all the steps of the method described above and in the following when said program is run on a computer.

The invention further relates to a computer program product comprising program code means stored on a computer readable medium for performing the method described above and in the following when said computer program product is run on a computer. The computer readable medium may comprise magnetic tape, optical disc, digital video disk (DVD), compact disc (CD or CD-ROM), mini-disc, hard disk, floppy disk, ferro-electric memory, electrically erasable programmable read only memory (EEPROM), flash memory, EPROM, read only memory (ROM), static random access memory (SRAM), dynamic random access memory (DRAM), synchronous dynamic random access memory (SDRAM), ferromagnetic memory, optical storage, charge coupled devices, smart cards, etc.

As the advantages of the above aspects of the invention and their respective preferred embodiments correspond to advantages of the method of transmitting customised program data and its corresponding embodiments described above and in the following, these will not be described again.

### BRIEF DESCRIPTION OF THE DRAWINGS

The invention will be explained more fully below in connection with preferred embodiments and with reference to the drawings, in which:

FIG. 1a shows a first example of data signals according to an embodiment of the invention;

FIG. 1b shows a second example of data signals according to an embodiment of the invention;

FIG. 1c shows a third example of a data signal according to the invention;

FIG. 2 shows a schematic view of a first example of a multicast communications system according to an embodiment of the invention;

FIG. 3a shows a schematic view of a second example of a multicast communications system according to an embodiment of the invention;

FIG. 3b shows a schematic view of a third example of a multicast communications system according to an embodiment of the invention;

FIG. 3c shows a schematic view of a fourth example of a multicast communications system according to an embodiment of the invention;

FIG. 4 shows a fourth example of data signals according to an embodiment of the invention;

FIGS. 5a-c show a block diagram of a system according to an embodiment of the invention illustrating the data flow at different times in FIG. 4; and

FIG. 6 shows five transmission channels transmitting data signals corresponding to a multi-threaded story.

### DETAILED DESCRIPTION OF PREFERRED EMBODIMENTS

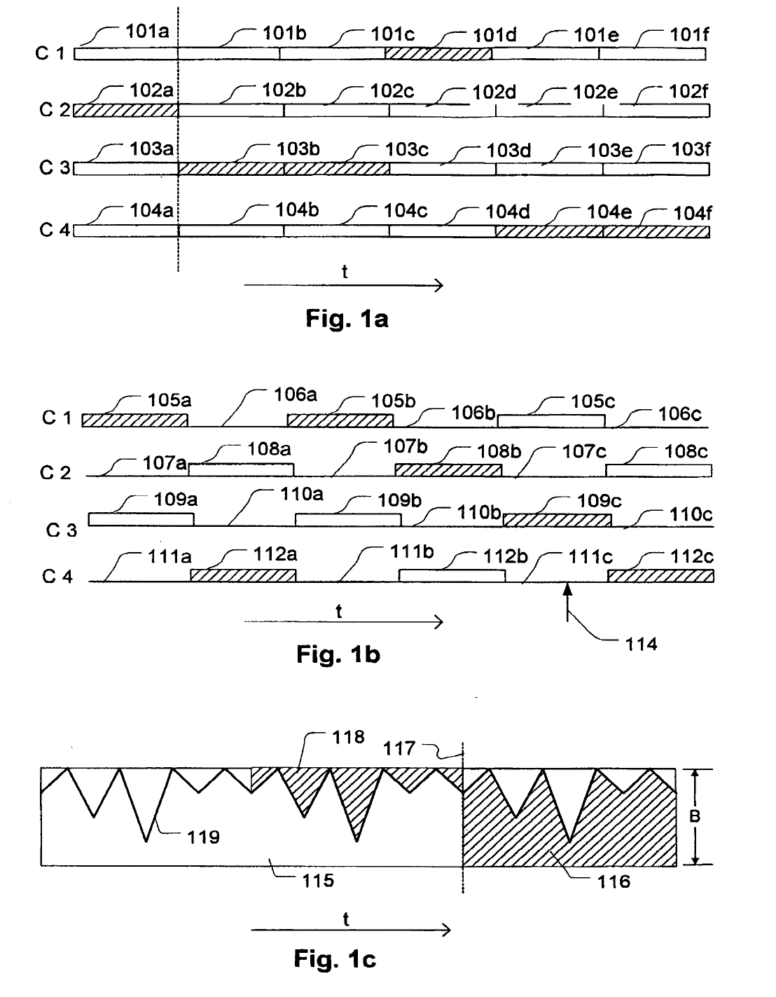

FIG. 1a shows a first example of data signals according to an embodiment of the invention. The data signals are transmitted via four transmission channels C1 through C4, and they each comprise respective sequences of program sections 101a-f, 102a-f, 103a-f, and 104a-f. In the example of FIG. 1a, the transmission channels C1-C4 transmit the sequences in parallel and all sections have substantially the same duration. The sections may comprise segments of a television broadcast, where each segment may comprise part of a television program, such as individual commercials of a commercial break, news spots of a news program, or the like. At the end of a program section, a receiver may switch from one channel to another, thereby receiving a customised sequence of the sections. As an example, the shaded sections 102a, 103b, 103c, 101d, 104e, and 104f in FIG. 1a illustrate a sequence of sections that is routed to a given receiver.

In the case of streaming video a viewer may initially watch the content of channel C2 which is transmitted via the section 102a. At the end of section 102a, a software program on the viewer's computer automatically switches to channel C3 such that the viewer watches the content from this channel in the subsequent time intervals, corresponding to the sections 103b-c. Preferably, the switch is performed sufficiently smooth for the viewer not to notice that the channel has been switched. For example the sections may contain different news reports of, for example, 30 seconds to 10 minutes duration. Different users may receive different news reports corresponding to different sections depending on their news preferences and language preferences. In the example of FIG. 1a, all the intervals and sections are equally long. Alternatively or additionally, the intervals may vary in length and one section may span over more than one interval. For example, sections 104e and 104f may be one section comprising a longer news report which is not interrupted by a switch. Preferably, the end of a section is synchronised with the beginning of the next selected section to make a smooth switch possible, e.g. the end of sections 101a-104a are mutually synchronised and they are synchronised with the start of sections 101b-104b. However, small deviations from perfect synchronisation may occur, e.g. due to variations in the transmission times of the different transmission channels, or due to details of the switching process. However, these deviations may be acceptable, as they may be compensated for, e.g. by utilising a data format which allows the embedding of timing information such as the display time in the program sections. Consequently, the program sections may be transmitted slightly before their scheduled display time, and the timing information may then be used by the receiver and/or player to synchronise the actual display of the program sections. An example of such data formats is the MPEG-4 standard, as will be described in connections with FIG. 1c. It should be noted, however, that the larger the variations that need to be compensated for, the larger the buffer size requirements at the receiver and/or player in order to be able to buffer the received data prior to the actual display. According to this embodiment, there are a large number of different ways of selecting a customised sequence. In a system with N channels, each multicasting a sequence of M sections of a program, e.g. spots of a commercial break, there are N^{M} possible customised sequences. Consequently, the method according to the invention provides a high degree of individualisation on a limited bandwidth.

FIG. 1b shows a second example of data signals according to an embodiment of the invention. The signals are transmitted via four channels C1-C4, each comprising a sequence of program sections 105a-c, 108a-c, 109a-c, and 112a-c. In the example of FIG. 1b, the program sections are separated by intervals 106a-c, 107a-c, 110a-c, and 111a-c, respectively, where no program data is transmitted. As in FIG. 1a, the time intervals during which program sections are transmitted are of substantially the same length and they are substantially synchronised. In the example of FIG. 1b, program sections are transmitted via the transmission channels C1 and C3 during time intervals where there are blank intervals on the transmission channels C2 and C4. Hence, the transmission channels are divided into two alternating sets of channels. According to this embodiment, a receiver which is receiving data from a channel of one of these sets may connect to a channel of the other set prior to the actual switching time without increasing the bandwidth load. For example, at the time indicated by the arrow 114, a receiver may receive section 109c from channel C3. At the end of this section 109c, the receiver is scheduled to switch reception to channel C4 to receive section 112c. According to this embodiment of the invention, the receiver may connect to channel C4 already at time 114. As there is no program data transmitted on channel C4 during the time interval 111c around time 114, the bandwidth load is not significantly increased due to the additional connection to channel C4. However, at the end of section 109c, a smooth switch may be performed, as no additional time for connecting to channel C4 has to be taken into account. Hence, by decreasing the bandwidth utilisation and reducing the possible combinations of possible switches, the embodiment of a data signal of FIG. 1b lowers the requirements for the system to provide short connection times when switching to a new channel. The reason is that it is possible to start connecting in advance without increasing the bandwidth load until the desired section starts. It should be noted that small amounts of data may be transmitted during the blank intervals, e.g. control data facilitating the connection and/or the switching. It should further be noted that combinations of more than two sets of channels and/or more than two channels per set are possible within the scope of the invention. Furthermore, it should be noted that, in the example of FIG. 1b, the respective lengths of the intervals 106a-c, 107a-c, 110a-c, and 111a-c are substantially the same as the length of the program sections 105a-c, 108a-c, 109a-c, and 112a-c. Alternatively, the intervals between transmitted program sections may be of a different length.

FIG. 1c illustrates the utilisation of the available bandwidth according to an embodiment of the invention. In this example the bandwidth usage of two consecutive program sections 115-116 is shown as a function of time. At each time a given fraction of the available bandwidth B is used by the current section, as indicated by the line 119. According to this embodiment of the invention, the unused fraction 118 of the available bandwidth during transmission of section 115 may be used to initiate the transmission of the subsequent section 116. After the transmission of section 115 is finished, the subsequent section 116 may utilise as much bandwidth as necessary, up to the available bandwidth B. Consequently, a more effective utilisation of the available bandwidth is achieved. At the same time, the switch between two consecutive sections may be performed more smoothly, even if the sections of different sequences are not well synchronised. Preferably, the data signals may comprise data in an object-oriented format, such as the MPEG-4 format, where the data sections comprise objects and where each object has a property attached to it indicating the starting time of its processing. The object may then be transmitted in advance but its processing, e.g. its display, will not start before the specified starting time. Consequently, by connecting to a channel prior to the actual switching time 117, unused bandwidth may be utilised to transmit data of a subsequent program section.

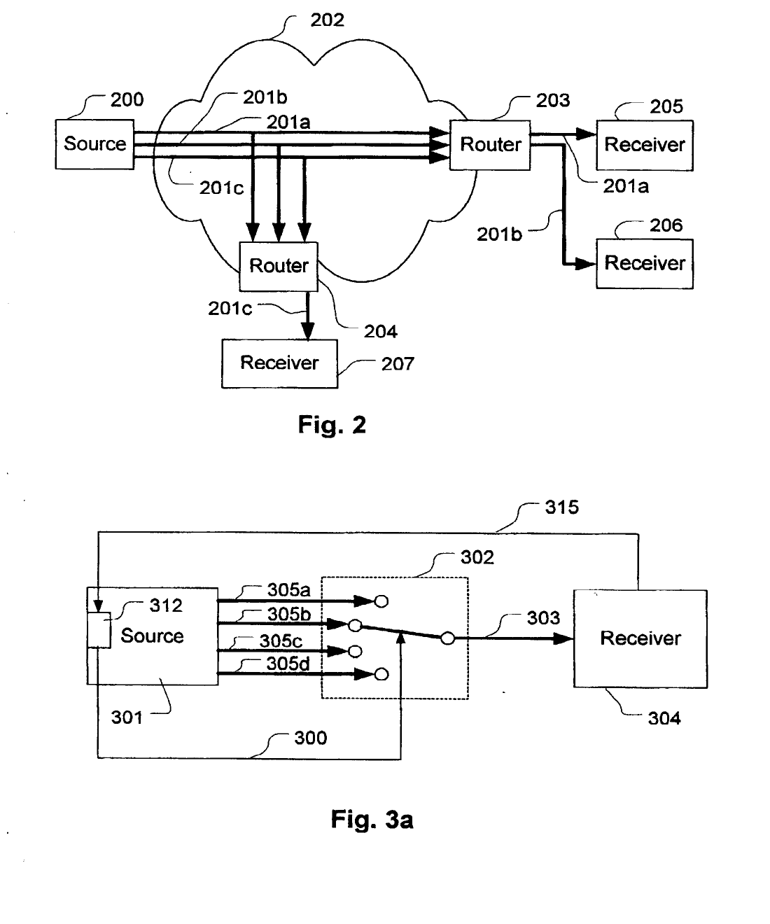

FIG. 2 shows a first example of a multicast communications system according to an embodiment of the invention. The system comprises a program source 200 which transmits data via three channels 201a-c of a communications network 202, preferably an IP multicast enabled network, to a number of receivers 205-207. The program source 200 may, for example, be a computer connected to the communications network 202 via a network adapter. Preferably, the transmission uses one or more suitable protocols, such as TCP, UDP, HTTP, PTP, or RTSP, on top of an IP protocol. The system further comprises routers 203-204 as part of the communications network 202. The routers 203-204 receive all three channels 201a-c, but they only route one channel further to the respective transmission links to corresponding ones of the receivers 205-207. In the example of FIG. 2, receivers 205-206 are connected to router 203 and receive channels 201a and 201b, respectively, while receiver 207 is connected to router 204 and receives channel 201b. For example, in the IP multicast framework using the Internet Group Management Protocol (IGMP), the receivers 205-207 each join a multicast group represented by a multicast group address and, subsequently, receive the data transmitted to the corresponding group. In the example of FIG. 2, there are three IP multicast groups corresponding to the three transmission channels 201a-c. For example, when a receiver 205 signals to the corresponding router 203 to switch to another group, the transmission of the current channel 201a from the router 203 to the receiver 205 is stopped at the router 203, and the transmission of the channel corresponding to the other group is initialised instead. This has the advantage of limiting the bandwidth required by the connection between the receivers 205-207 and the corresponding routers 203-204 of the communications network 202. In many situations it is this connection from the end-user to the nearest router, e.g. an Internet Service Provider (ISP) which is the largest bottleneck of the transmission from the program source to the end-user. It should be noted that a multicast group may correspond to more than one transmission channel from different program sources. For example, in this case a transmission channel may be identified by specifying a multicast group address and a program source address.

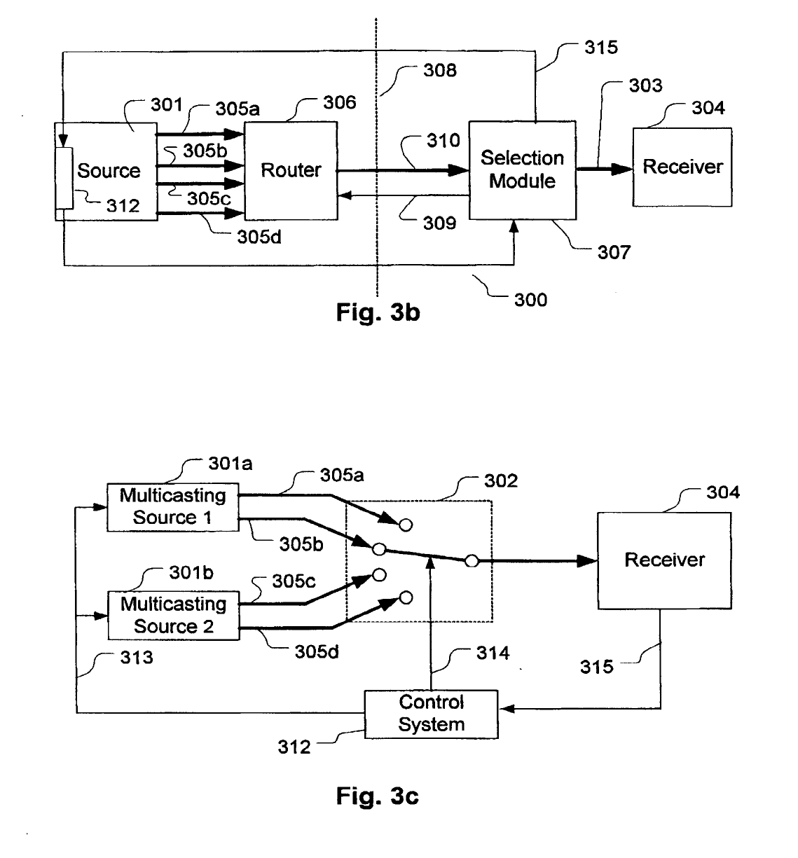

FIG. 3a shows a schematic view of a second example of a multicast communications system according to an embodiment of the invention. The system comprises a program source 301 transmitting program data via a plurality of transmission channels 305a-d to a switching circuit 302. At the switching circuit 302, one of the transmission channels is routed via the transmission link 303 to a receiver 304. The source 301 comprises a control module 312 which is connected to the switching circuit 302 via a first control connection 300. According to this embodiment, the control module 312 of the source 301 controls, via the first control connection 300, which channel is routed by the switching circuit 302 to the receiver 304. According to the invention, the program data transmitted via the transmission channels 305a-d comprises respective sequences of program sections, e.g. as described in connection with FIGS. 1a-c. Hence, by causing the switching circuit 302 to switch to predetermined channels at predetermined switching times, the source 301 controls the content of the sequence of sections received at the receiver 304. The system may further comprise a second control connection 315 from the receiver 304 to the control module 312 of the source 301 allowing to send control signals, such as subscriber information or information about whether the receiver 304 is on-line, from the receiver 304 to the source 301. Consequently, it is possible for the source 301 to let the content and order of the program sections transmitted via the transmission channels 305a-d be dependent on the set of receivers connected to the system at any point in time.

FIG. 3b shows a schematic view of a third example of a multicast communications system according to an embodiment of the invention. As in the embodiment of FIG. 3a, the system comprises a source 301 transmitting program data comprising sequences of program sections via a number of transmission channels 305a-d, and a receiver 304 receiving a customised sequence of program sections. According to this embodiment, the system further comprises a router 306 and a selection module 307 implemented in hardware and/or software. Together, the router 306 and the selection module 307 implement a functionality corresponding to the switching circuit 302 of FIG. 1a. However, it is an advantage of this embodiment of the invention, that the router 306 and the selection module 307 may be located at different locations. For instance, the router 306 may be located at an ISP and the selection module 307 may be located in the proximity of the receiver 304 The selection module is connected to the control module 312 of the source 301 via the first control connection 300 and receives control signals from the source 301 controlling the switching of transmission channels. The control signals received from the source 301 cause the selection module to send control signals via the control connection 309 to the router, thereby controlling which transmission channel is routed via the transmission link 310 from the router 306 to the selection module 307 and further via the connection 303 to the receiver 304.

It is an advantage of the invention that the commands sent via connection 309 to the router may be implemented as standard IP multicast protocol commands which may be understood by a standard router, thereby providing a solution which is easily implemented.

Alternatively, the selection module 307 may be located in connection with the router 306. In the case of the Internet this corresponds to locating the selection module on the other side of the ISP/user interface 308, i.e. away from the receiver. This has the advantage that the selection module 307 does not use any of the resources of the receiver or other devices at the end-user's site. This has the advantage of lowering the computational requirements of the receiver 304 and avoids the need for an alternative dedicated device implementing the selection module at the end user's location. This may be particularly useful for low-performance and/or dedicated hardware devices such as mobile phones or PDA's. The selection module 307 may also be implemented in the same hardware device as the router unit 306.

The ISP/user interface 308 is the interface between the ISP and the user and may comprise a network link such as a telephone line, an optical connection, a wireless link or the like. It is an advantage of the invention that only one program stream, e.g. video, sound, or the like, needs to be transmitted via this interface at a time. Hence, the interface 308 does not generate a bottleneck of the transmission despite of its low bandwidth. It is noted, however, that low bandwidth data, such as control signals, or the like, may be sent via the interface 308 in parallel.

FIG. 3c shows a schematic view of a fourth example of a multicast communications system according to an embodiment of the invention where the program source is divided up into two separate sources 301a-b. Each of the sources 301a-b transmits program data via corresponding transmission channels 305a-b and 305c-d, respectively, to the switching circuit 302 which selects one of the incoming transmission channels and routes it to the receiver 304. The system further comprises a control system 312 which controls the switching circuit 302 via the control connection 314. The control system also controls the program sources 301a-b via a control connection 313. Hence, according to this embodiment, the control system 312 controls which program content is transmitted from the sources 301a-b and it controls the timing of the transmission of program sections from the sources 301a-b as well as the switching of the switching circuit. This has the further advantage of allowing to place the multicasting source units 301a-b and the control system 312 on different computers positioned at different locations. The introduction of a source control connection 313 has the advantage of being able to let the combination of sections in the sequences be dependent on the set of receivers 304 connected to the system at any point in time. As described above, the information about connected receivers may be received from the receivers via a control connection 315. For example, the control system 312 may receive information about which users are connected to the multicast system via their respective receivers at a given time. Furthermore, user profiles about registered users may be stored by the control system. The user profiles may comprise data such as address, age, profession, preferences, sex, etc. The user profile data about the users which are connected at a given time may then be used for selecting, for example, advertisement sections and their order and timing within the different transmission channels for an upcoming commercial break. The selection based on the user profile data of the currently connected users may thus be used to optimise the selection of advertisements with respect to the properties of the current user community.

It is understood that instead of the switching circuit 302, the system may comprise a combination of a router and a selection module as described in connection with FIG. 3b.

In FIGS. 3a-c, the program source 301 may comprise a computer or computer system connected to the communications network, e.g. via a network adapter or network interface. The program source 301 may further comprise a computer adapted to execute a streaming server software program adapted to stream a number of separate channels of content in a streaming format such as MPEG-4. Alternatively or additionally, the program source 301 and/or the control system 312 may comprise a computer or computer system adapted to execute a software program controlling the streaming server software program, the switching circuit 302, and/or the selection module. The receiver 304 may comprise a computer, a set-top-box or a mobile device, such as a mobile phone, PDA, communicator, etc. Preferably, the receiver 304 comprises a streaming media player. Preferably, the transmission uses one or more suitable protocols, such as TCP, UDP, HTTP, RTP, or RTSP, on top of an IP protocol. The control connections 300, 313-315 may be separate communications links or they may be embedded in the transmission channels. For example, the control connections may be TCP/IP connections.

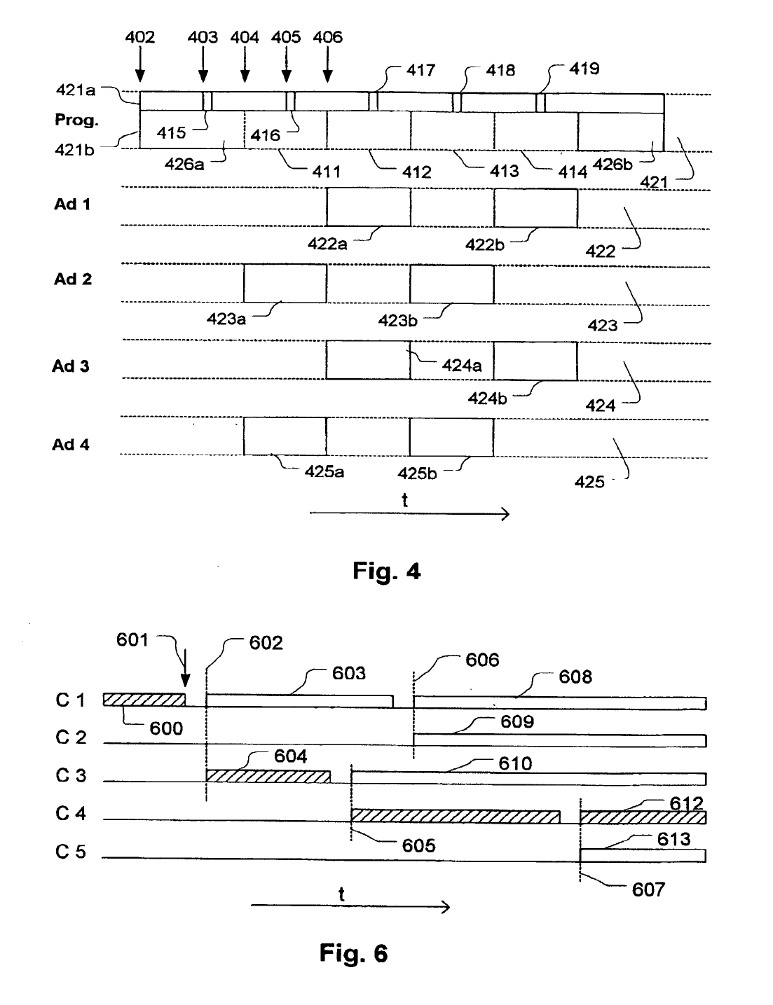

FIG. 4 shows a fourth example of data signals according to an embodiment of the invention. The signals are transmitted via a program channel 421 and advertising channels 422-425, respectively. FIG. 4 illustrates an example of an embodiment of the invention, where a TV station multicasts a TV program channel 421 over the Internet using, for example, the MPEG-4 format. The TV program presentation transmitted on channel 421 includes, embedded in the presentation 426a-b, reference objects 411-414 comprising references to external objects. According to the invention, the exact address of the external objects is not determined until just before the object is needed, and the address may be different for different users. Consequently, a customisation of the TV content is achieved. Each available space 411-414 for external objects may be filled with one of a number of alternative objects for each user. The channels 422-425 comprise alternative objects which may be referred to by the reference objects 411-414 and, thus, fill the corresponding available spaces in the program content. The channels 422 and 424 comprise alternative objects 422a and 424a for the space 412 and alternative objects 422b and 424b for the space 414, respectively. The channels 423 and 425 comprise alternative objects 423a and 425a for the space 411 and alternative objects 423b and 425b for the space 413, respectively. The available bandwidth and the time of transmission of the reference objects 411-414 determine the maximum available bandwidth and the maximum time of transmission of the corresponding objects transmitted on the channels 422-425. The size of the objects 422a-b, 423a-b, 424a-b, and 425a-b measured in bits is determined by the average bandwidth used times the actual time of transmission. Note, however, that the time of transmission is not necessarily equal to the time during which the object is displayed to the user. If, for example, the object 422a is transmitted faster because it is compressed, the actual transmission may end prior to the end of the allocated time slot for the transmission.

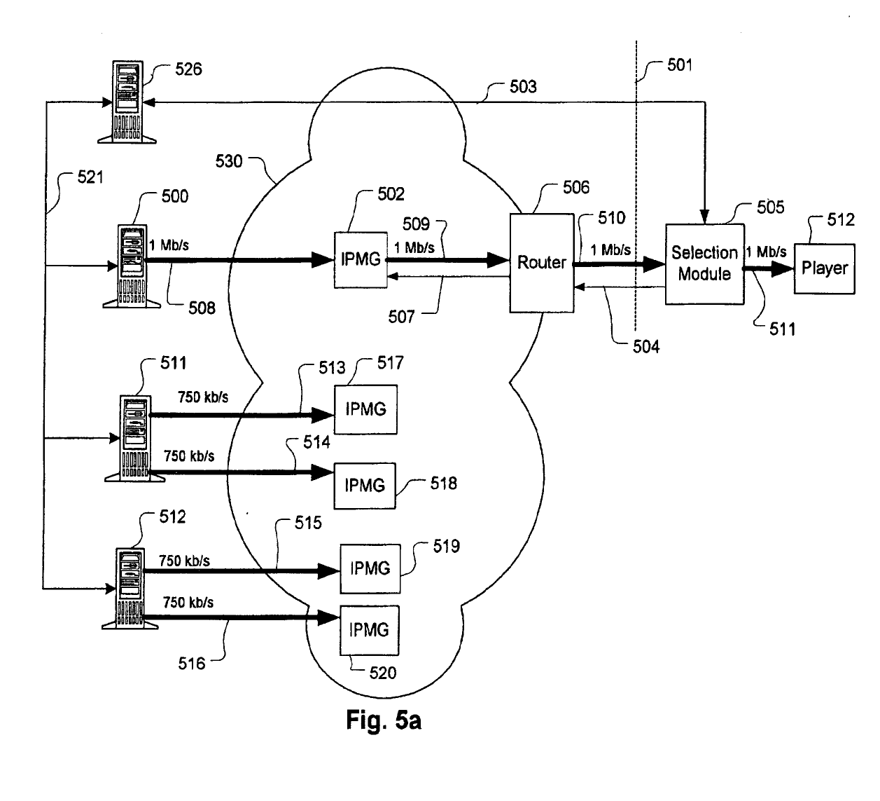

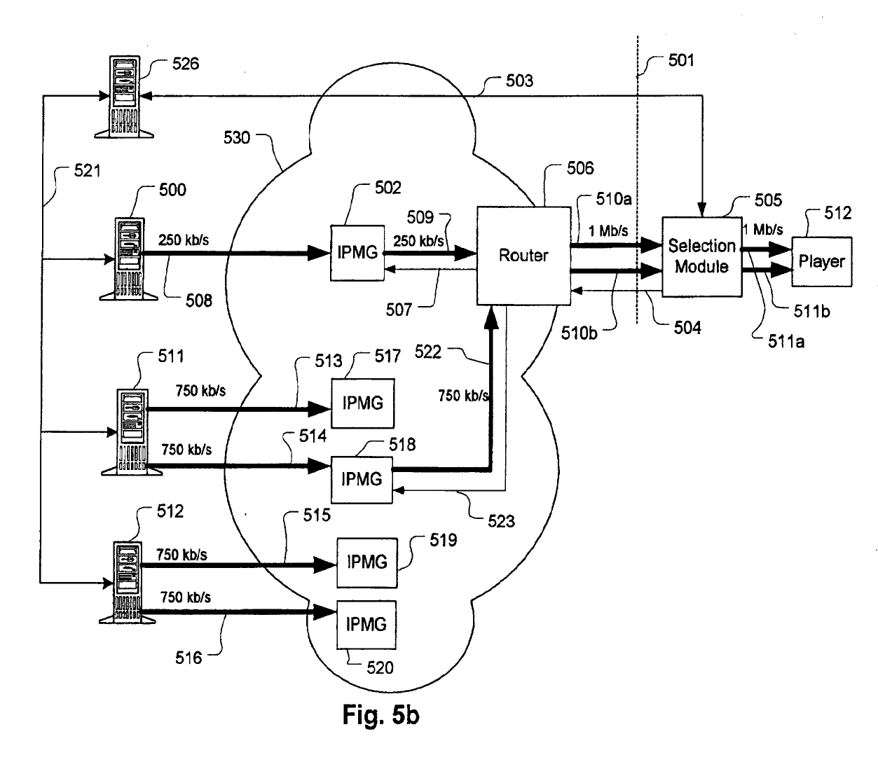

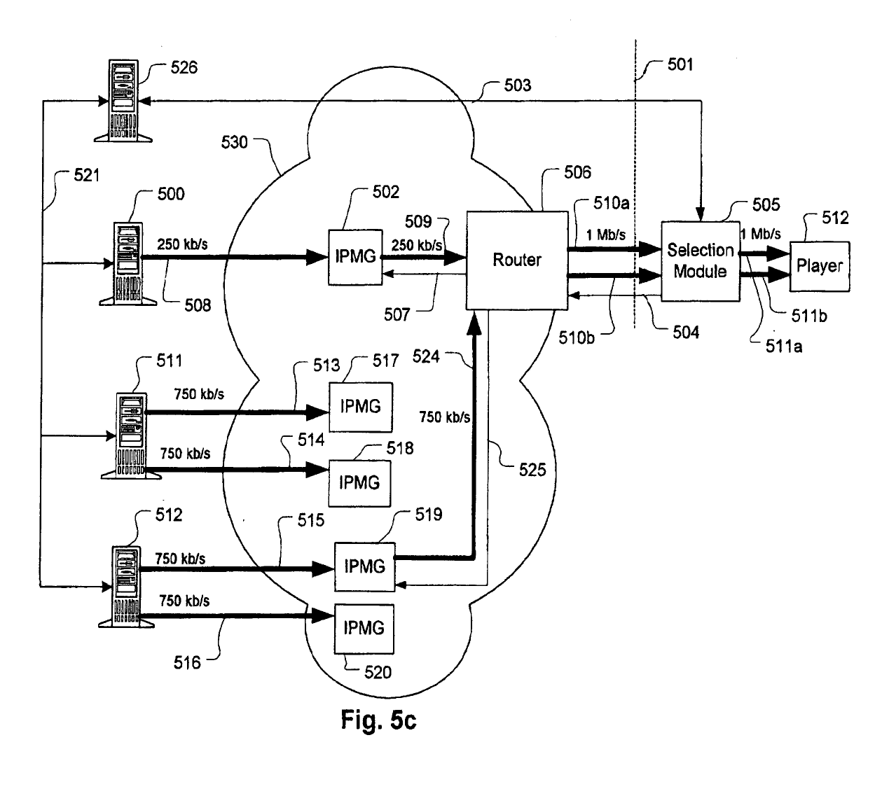

The program signal 421 further comprises data items 415-418 which indicate the start of the corresponding reference objects 411-414 and the data item 419 which indicates the end of the reference object 414 and, thus, the switch back to the presentation 426. The data items 415-419 may be marks, tags, executable program code, scripts, or the like, causing a selection module to switch reception from one channel to another, as will be described in greater detail in connection with FIGS. 5a-c. The data items 415-419 may be embedded in the program signal 421, thereby using a small fraction 421a of the available bandwidth, while the major part of the available bandwidth 421b may be used by the program data. Alternatively, the data items 415-419 may be transmitted as a part of a separate control signal. The arrows 402-406 indicate different points in time during the transmission of the program data via the parallel transmission channels 421-425. These will be described in connection with FIGS. 5a-c.

FIGS. 5a-c show a block diagram of a system according to an embodiment of the invention illustrating the situation at different points in time of the transmission of the data signals of FIG. 4. The system comprises a TV program server 500 and two advertising servers 511-512. The program server 500 transmits program data, for example a television show, a movie, a news or sports program, near video on demand (N-VOD), training programs, product presentations, or the like. In this example, the program data corresponds to the data signal 421 in FIG. 4 and it is transmitted via a first transmission channel 508 and a first IP multicast group 502 of the IP multicast enabled communications network 530. Preferably, the communications network comprises the Internet where access to the Internet may be provided to end-users by one or more ISPs. The advertisement servers 511-512 transmit customised advertisement content via transmission channels 513-514 and 515-516, respectively, and the multicast groups 517-518 and 519-520, respectively. Here, a multicast group is an entity of the communications network 530 which may be implemented as a set of address tables in the routers of the network 530 which comprise multicast group addresses, each identifying one of the multicast groups 502 and 517-520. Hence, the multicast groups 502 and 517-520 correspond to a predetermined set-up of the network 530 including a predetermined number of routers, possibly of multiple ISPs. The system further comprises a router 506 which may receive data signals from a plurality of multicast groups and route data from selected multicast groups to a selection module 505 via a communications link 510.

The router 506 may be directly connected to the selection module 505, i.e. the router may be the last router on the path from one of the servers to the selection module. Alternatively, the router may be another router of the communications network. In one embodiment, the router 506 is selected dynamically by the IP multicast protocol. For example, if two receivers have subscribed to the same program sequence, the router 506 may be selected to be the last common router on the paths to the respective receivers.

The selection module 505 may then forward the data signal via a data connection 511 to a player 512 which, preferably, comprises a streaming media player for displaying the received TV content.

The selection module 505 may be implemented in the same device as the player 512. It may comprise a suitably programmed computer, a set-top-box or a mobile device, such as a mobile phone, PDA, communicator, etc.

Alternatively, the selection module may be implemented separate from the player, for example as a computer program executed on a network server of an ISP. The selection module 505 is further connected via a control connection 503 to a control server 526. Preferably, the control connection 503 is a TCP/IP connection via the communications network 503 which, preferably, is provided by the same ISP. In FIGS. 5a-c, the control connection is shown as a separate connection. Alternatively, it may be provided via the router 506. For example, the control signals may be embedded in the program signal 421 in FIG. 4, e.g. by multicasting a number of alternative control signals for respective groups of viewers. The control server is connected to the program server 500 and the advertisement servers 511-512 via a control connection 521, e.g. a computer network, such as a LAN, WAN, intranet, internet or the like. Hence, the control server 526 may synchronize the transmissions of the program server 500 and the advertisement servers 511-512, thereby ensuring a continuous data flow to the player 512. For example, the control server 526 may act as a client and the servers 500 and 511-512 as servers of a client/server architecture. The TV program server 500 and the advertisement servers 511-512 include respective computer systems adapted to execute IP multicast capable streaming server software programs. In the example of FIG. 5a, the TV program is aimed at viewers with a predetermined minimum bandwidth, which in this example is assumed to be 1 Megabits per second. This limit may be determined by the ISP/user interface 501, i.e. the interface between the ISP and the user, which may be a communications link like a telephone line, an Asymmetric Digital Subscriber Line (ADSL), an ISDN connection, an optical connection, a wireless link, or the like. The control server 526 may comprise a computer or computer system adapted to execute a software program controlling the streaming server software programs executed on the servers 500 and 511-512. Preferably, the program data transmitted by the program server 500 and the advertisement servers 511-512 comprise objects of an object-oriented standard for multimedia transmission, such as the MPEG-4 standard.

FIG. 5a illustrates the data flow in the system after a user has requested to receive a TV program, e.g. via an input means, such as a remote control, a button, a pointing device, or the like, of the selection module 505 or the player 512. The time of this request is indicated by arrow 402 in FIG. 4. The request may be sent from a selection software program executed on the selection module 505 to the control server 526 via the control connection 503. In response to the request, the control server 526 sends the address of the corresponding multicast group 502 to the selection module 505 via the control connection 503. Subsequently, the selection module 505 sends a request for the reception of data corresponding to the multicast group 502 to the router 506 via control connection 504. Alternatively, if the address of the corresponding multicast group 502 is already stored in a storage medium of the selection module 505, the selection module may request the content directly from the router 506. The request sent from the selection module 505 to the router 506 may comprise a ‘join-multicast-group’ request, causing the router 506 to request data from the multicast group 502, as represented by connection 507 in FIG. 5a. This request may be implemented by standard multicast routing techniques and may comprise forwarding the request to multiple routers (not shown) of the network 530. It is further noted that some versions of the IP multicast protocols, e.g. the Internet Group Management Protocol version 3 (IGMPv3), allow switching between different sources within the same group. When the router 506 has requested the data, data corresponding to the multicast group 502 is routed to the router 506, indicated by the data connection 509. The received data corresponds to the data signal 421 of FIG. 4. The router 506 forwards the received data via the data connection 510 to the selection module 505 which, in turn, forwards it to the player 512 for display, resulting in the program appearing on the players display.

Now referring to FIG. 5b, at the time indicated by arrow 403 in FIG. 4, a data item 415 indicating an advertising break is embedded in the TV program stream 421 of FIG. 4. When the selection module 505 receives the data item 415, it triggers a request from the selection module 505 to the control server 526 via the control connection 503. The control server 526 replies with an IP multicast group address indicating which multicast group to receive a customized advertisement from, in the example of FIG. 5b multicast group 518. Subsequently, the selection module 505 initiates a ‘join-multicast-group’ request which is forwarded by the router 506, and a connection to the multicast group 518 is established, thereby initiating the reception of program data corresponding to the data signal 423 in FIG. 4 from the server 511. At the time 403 of the connection, the advertising server 511 transmits no or little content to the multicast group 518 via the transmission channel 517, corresponding to the data signal 423 at time 403 in FIG. 4. However, a connection is established. This has the advantage that an overload of the user's connection 510 to the ISP/user interface 501 is avoided, because at the time 403 the TV program server 500 is still transmitting approx. 1 Megabits per second. At the time indicated by arrow 404 in FIG. 4, the control server 526 causes the program server 500, via the control connection 512, to lower the TV program bandwidth load transmitted by the server 500 via the transmission channel 508. In the example of FIG. 5b, the bandwidth is lowered to 250 kilobits per second, still providing bandwidth for control signals, as indicated by the bandwidth fraction 421a of FIG. 4, and, at the same time, providing bandwidth for the transmission channel 423 of the alternative customized advertising channels 423 and 425. Alternatively, the program server 500 may signal to the control server 526 when it is time to transmit advertisements. Correspondingly, the control server 526 requests the advertising server 511, via the control connection 521, to start transmitting an advertising program section 423a using the available bandwidth, in the current example 750 kilobits per second, via the transmission channel 514. Additionally, other advertising servers may start transmitting alternative program sections to be received by other users, as well as the server 511 may transmit other sections via different transmission channels. The advertisement program section 423a is addressed to the multicast group 518. As the router 506 has requested to receive data addressed to the multicast group 518, the data is forwarded to the router 506 and onward, via the selection module 505, to the player 512. It is an advantage of the invention that the bandwidth required at the ISP/user interface 501 does not exceed the original maximum bandwidth, in this example 1 Megabit per second while the advertising servers 511-512 multicast customised advertising spots. Consequently, the hardware requirements and the needed bandwidth to distribute advertisings to a large number of concurrent users are low. Preferably, the program data sent to the selection module 505 by the program server 521 may have a script embedded in the MPEG-4 presentation, which is downloaded as one of the first objects of the TV program and, subsequently, interpreted by the player 512. Here, the term script comprises a sequence of instructions indicating how a multimedia sequence of files should be presented, e.g. the sequence of images and sounds, their timing, their position on the screen, the possible results of user interactions, the steps to be performed upon receipt of a data item 415-419, respectively, etc. The data items 415-419 of FIG. 4 may be objects of an MPEG-4 scene including an address, e.g. a URL referring to the control server which may redirect a subsequent request by the selection module to the relevant server 500 or 511-512. In the example of FIGS. 5a-c, each transmission channel is transmitted to a separate IP multicast group. Alternatively, more than one channel may be transmitted to the same group.

Now referring to FIG. 5c, at the time indicated by the arrow 405 in FIG. 4, the next data item 416 indicating an advertising mark is transmitted and, upon receipt of this mark, the selection module 505 starts connecting to the multicast group 519 as was described in connection with FIG. 5b. At the time indicated by the arrow 406 in FIG. 4, the selection module, in response to a control signal received from the control system 526 via the control connection 503, sends a ‘leave-multicast-group’ request and the address of the multicast group 518 to the router 506, via the control connection 504. In response to this request, the router 506 stops transmitting the data received from the IP multicast group 506 and forwards the request onward according to the IP multicast routing protocol used. Furthermore, at this point in time, the advertising server 512 is triggered by the control server 526, via the control connection 521, to start transmitting an advertising program section 424b via the transmission channel 515 to the multicast group 519. The router 506 receives the data and forwards it via the selection module 505 to the player 512.

FIG. 6 shows five transmission channels transmitting data signals according to the invention corresponding to a multi-threaded story. The signals may be transmitted to multiple users, for example using the embodiment of FIGS. 5a-c. The term multi-threaded story comprises stories with multiple paths and endings, e.g. a story comprising decision points during the story line allowing two or more alternative continuations of a story. The first transmission channel C1 in FIG. 6 transmits the first part or thread 600 of a story to all users. Initially, no data is transmitted via the remaining transmission channels C2-C5. At time 601 the users are presented with a choice, e.g. by presenting 2 alternative continuations on the display of the player and requesting an input from the user. A user is requested to input a selection via an input means, e.g. a remote control, a mouse, a keyboard, or the like, of a player or a selection module prior to a predetermined time 602. If a user selects a first choice, the thread 603 is received, i.e. the reception continues via transmission channel C1. If a user selects a second choice, the selection module requests to receive channel C3 and thread 604 is received. If the user fails to respond, a default continuation may be selected automatically. Assuming the user has chosen thread 304, he or she will be presented with another choice prior to the next decision point 605. It should be noted that the alternative decision points 605 and 606 in this example are not positioned at the same time. In the example of FIG. 6, the story has five endings corresponding to threads 608-610, 612, and 613. In this example, all the decision points 602, 605-607 present two alternatives to the users. Alternatively, different decision points may have different numbers of alternatives, and two or more paths may merge again as a result of a subsequent choice. Hence, the invention provides a flexible method for the multicasting of multi-threaded stories without requiring a large amount of bandwidth.

Alternatively or additionally, the continuations of the multi-threaded story may be selected automatically by a processing unit on the basis of information about the user stored in the receiver or the selection module. The information may include information such as age, sex, interests, etc.

It is further understood, that an embodiment of the invention may be used to transmit data which is customised according to the hardware and/or available resources of the receiver. For example, a mobile phone may receive program sections which require less computational resources than a stationary PC.

It should further be noted that the invention is not limited to one customisable program section at a time. Within the scope of the invention it is possible to include multiple overlapping reference objects each referring to a number of alternative objects to be received via different transmission channels.

1. A method of transmitting customised program data from a number of program sources to a receiver, the method comprising the steps of
multicasting a first data signal from a first one of the number of program sources via a first transmission channel of a communications network, the first data signal comprising a first sequence of program sections;
multicasting a second data signal from a second one of the number of program sources via a second transmission channel of the communications network, the second data signal comprising a second sequence of program sections;
transmitting a first control signal from a control means to a selecting means associated with the receiver, the first control signal being indicative of a customised sequence of program sections;
in response to the first control signal causing the receiver by the selecting means to selectively receive program sections from selected ones of the first and second transmission channels in a predetermined order corresponding to the customised sequence of program sections.

2. A method according to claim 1, wherein the second sequence of program sections has a predetermined temporal relationship to the first sequence of program sections.

3. A method according to claim 2, wherein the second sequence of program sections is substantially synchronised with the first sequence of program sections.

4. A method according to claim 1, wherein at least a first program section of the customised sequence of program sections comprises a program data object.

5. A method according to claim 1, wherein the step of multicasting a selected one of the first and second sequences of program sections comprises transmitting the corresponding first or second sequence of program sections via an IP multicast protocol.

6. A method according to claim 1, wherein the step of causing the receiver by the selecting means to selectively receive program sections comprises the step of switching between receiving data from the first transmission channel and the second transmission channel in a predetermined order.

7. A method according to claim 1, wherein the step of causing the receiver by the selecting means to receive program sections further comprises the steps of
receiving program sections of the first and second sequences of program sections at a node of the communications network via the corresponding first and second transmission channels;
transmitting the customised sequence of program sections from the node to the receiver.

8. A method according to claim 7, wherein the method further comprises the steps of
receiving a first data item from the control means by the selecting means, the first data item being indicative of at least a selected one of the first and second program sources;
transmitting a second data item from the selecting means to the node of the communications network, the second data item corresponding to a request for receiving program sections of the corresponding first or second sequence of program sections from the corresponding first or second program source.

9. A method according to claim 1, wherein the customised sequence of program sections is selected at least partly in response to one or more inputs received from a user via an input means.

10. A method according to claim 8, wherein the first data item is indicative of a plurality of alternative program sections; and the method further comprises the step of selecting a second program section from the plurality of alternative program sections by the selecting means in response to an input received from a user via an input means.

11. A method according to claim 1, wherein a selected one of the first and second sequences of program sections comprises predetermined time intervals between the corresponding program sections.

12. A method according to claim 1, wherein the first and second sequences of program sections each comprise predetermined time intervals between the corresponding program sections; and the program sections of the first sequence of program sections are transmitted during time intervals corresponding to the predetermined time intervals between the program sections of the second sequence of program sections.

13. A method according to claim 1, wherein the method further comprises the steps of
receiving information about the receiver by the control means; and
in response to the received information, selecting a third program section by the control means to be transmitted as a part of a selected one of the first and second sequences of program sections.

14. A method of receiving customised program data by a receiver from a number of program sources, wherein a first one of the number of program sources multicasts a first data signal via a first transmission channel of a communications network, the first data signal comprising a first sequence of program sections, and a second one of the number of program sources multicasts a second data signal via a second transmission channel of the communications network, the second data signal comprising a second sequence of program sections; the method comprising the steps of
receiving a first control signal from a control means by a selecting means associated with the receiver, the first control signal being indicative of a customised sequence of program sections;
in response to the first control signal causing the receiver by the selecting means to selectively receive program sections from selected ones of the first and second transmission channels in a predetermined order corresponding to the customised sequence of program sections.

15. A method according to claim 14, wherein the second sequence of program sections has a predetermined temporal relationship to the first sequence of program sections.

16. A method according to claim 15, wherein the second sequence of program sections is substantially synchronised with the first sequence of program sections.

17. A method according to claim 14, wherein the step of causing the receiver by the selecting means to receive program sections further comprises the step of
receiving the customised sequence of program sections by the receiver from a node of the communications network, the node of the communications network being adapted to receive program sections of the first and second sequences of program sections via the corresponding first and second transmission channels and to generate and transmit to the receiver the customised sequence of program sections.

18. A method according to claim 17, wherein the method further comprises the steps of
receiving a first data item from the control means by the selecting means, the first data item being indicative of at least a selected one of the first and second program sources;
transmitting a second data item from the selecting means to the node of the communications network, the second data item corresponding to a request for receiving program sections of the corresponding first or second sequence of program sections from the corresponding first or second program source.

19. A method according to claim 14, wherein the customised sequence of program sections is selected at least partly in response to one or more inputs received from a user via an input means.

20. A method according to claim 14, wherein a selected one of the first and second sequences of program sections comprises predetermined time intervals between the corresponding program sections.

21. A system for transmitting customised program data from a number of program sources to a receiver, the system comprising
a first program source adapted to multicast a first data signal via a first transmission channel of a communications network, the first data signal comprising a first sequence of program sections;
a second program source adapted to multicast a second data signal via a second transmission channel of the communications network, the second data signal comprising a second sequence of program sections;
control means adapted to transmit a first control signal, the first control signal being indicative of a customised sequence of program sections;
a receiver adapted to receive program sections from selected ones of the first and second transmission channels; and
selecting means associated with the receiver and adapted to cause the receiver, in response to the first control signal, to selectively receive program sections from selected ones of the first and second transmission channels in a predetermined order corresponding to the customised sequence of program sections.

22. A receiver for receiving customised program data, the receiver comprising
receiving means for receiving a first data signal comprising a predetermined sequence of program sections; and
selecting means adapted to generate a control signal causing a routing means to select the predetermined sequence of program sections from a plurality of data signals and to route the predetermined sequence of program sections to the receiver, each one of the plurality of data signals comprising a respective sequence of program sections.

23. A system for communicating customised program data, the system comprising
a number of program servers adapted to transmit sections of program data via a communications network, each of the sections of program data carrying a corresponding multicast group address;
a client system adapted to receive program data via the communications network;
a control server adapted to send a target multicast address indicative of at least a first one of the sections of program data to the client system;
a selection circuit comprised in the client system and adapted to generate and send a first control signal comprising control commands adapted to cause a router of the communications network to receive and route to the client system sections of program data carrying the target multicast address.

24. A client system comprising
a communications circuit adapted to
receive sections of program data via a communications network, each of the sections of program data having associated a corresponding multicast group address, and
receive control data from a control server, the control data being indicative of a target multicast address identifying at least a first section of program data;
a processing unit adapted to generate a first control signal comprising control commands adapted to cause a router of the communications network to receive and route to the client system the at least first section of program data associated with said target multicast address; and
the communications circuit is further adapted to send the first control signal to a router of the communications network.

25. A data signal embodied in a carrier wave for use in a method according to claim 1, the data signal comprising a sequence of program sections.

26. A computer program comprising program code means for performing the method of claim 14 when said program is run on a computer.

27. A computer program product comprising program code means stored on a computer readable medium for performing the method of claim 14 when said computer program product is run on a computer.
